(19) United States
(12) Patent Application Publication
(10) Pub. No.: US 2002/0152076 A1
(43) Pub. Date: Oct. 17, 2002

(54) System for permanent alignment of text utterances to their associated audio utterances

(76) Inventors: Jonathan Kahn, Crown Point, IN (US); Nicholas A. Linden, Cedar Lake, IN (US)

Correspondence Address: SONNENSCHEIN NATH & ROSENTHAL, Sears Tower, Wacker Drive Station, P.O. Box 061080, Chicago, IL, 60606-1080, US

(21) Appl. No.: 09/995,892

(22) Filed: Nov. 28, 2001

Related U.S. Application Data
(60) Provisional application No. 60/253,632, filed on Nov. 28, 2000.

(51) Int. Cl. G10L 11/00

(52) U.S. Cl. 704/270

(57) ABSTRACT

The invention includes a computer implemented method for permanently aligning text utterances to their associated audio utterances. A mixer utility associated with a sound card first is found. The mixer utility, which has settings that determine an input source and an output path, is open. A first single audio utterance from a unitary audio file is played to produce a child single audio utterance. The child single audio utterance is recorded into a child audio file. This process is repeated until all first single audio utterances from the unitary audio file have been played.

### RELATED APPLICATION DATA

This patent claims the benefit of U.S. Provisional Application No. 60/253,632 under 35 U.S.C. § 119(e), filed Nov. 28, 2000, which application is incorporated by reference to the extent permitted by law.

### BACKGROUND OF THE INVENTION

1. Field of the Invention

The present invention relates in general to speech recognition software and, in particular, to a method and apparatus to permanently align text utterances to their associated audio utterances.

2. Background Information

Speech recognition (sometimes voice recognition) is the identification of spoken words by a machine through a speech recognition program. Since speech recognition programs enable a computer to understand and process information provided verbally by a human user, these programs significantly minimize the laborious process of entering such information into a computer by typewriting. This, in turn, reduces labor and overhead costs in all industries.

Speech recognition programs are well known in the art. Speech recognition generally requires that the spoken words be converted into text with aligned audio. Here, conventional speech recognition programs are useful in automatically converting speech into text with aligned audio. However, most speech recognition systems first must be “trained,” requiring voice samples of actual words that will be spoken by the user of the system.

Training usually begins by having a user read a series of pre-selected written materials from a text list for approximately 20 minutes into a recording device. The recording device converts the sounds into an audio file. From here, the speech recognition system transcribes the sound file (the user's spoke words) and aligns the pre-selected written materials with the transcription so as to create a database of correct speech-text associations for a particular user. This database is used as a datum from which further input speech may be corrected, where these corrections are then added to this growing correct speech-text database.

To correct further speech, the program as a function of the programs' efficiency transcribes words. A low efficiency of 60% means that 40% of the words are improperly transcribed. For these improperly transcribed words, the user is expected to stop and train the program as to the user's intended word, the effect of which is to increase the ultimate accuracy of a speech file, preferably to about 95%. Unfortunately, most professionals (such as doctors, dentists, veterinarians, lawyers, and business executive) are unwilling to spend the time developing the necessary speech files to truly benefit from the automated transcription. In general, because conventional systems require each user to spend a significant amount of time training the system, many users are dissuaded from using these programs.

As the inventor of this invention discovered, conventional speech recognition programs do not allow for the transfer of a corrected text utterances with aligned audio utterances from one computer system to the next. As an example, Dragon NaturallySpeaking® speech recognition software products by L&H Dragon Systems, Inc. of Newton, Mass., are held out to be advanced speech recognition solutions that features benefits to help professionals and other save time and money. However, the corrected text with aligned audio of the Dragon system remains in a buffer only so long as the current Dragon session remains open by the user. Once the user closes the current Dragon session, the corrected text with aligned audio is no longer available. Because the alignment of the text utterances to their associated audio utterances is not permanent, Dragon does not provide any way to transfer the Dragon text-audio alignment from a computer originating the text-audio alignment to other computers, even if these computers are connected across a computer network.

Since many professionals use more than one computer, it becomes highly inconvenient and expensive to train each computer and to recreate identical Dragon transcribed audio files on each computer of the user. As the inventor has discovered, in distributing speech files there is use for separate audio files for each utterance or word toward processing same into text either manually or automatically. The present invention addresses this need, as well as other needs in the art as would be understood by those of ordinary skill in the art reviewing the present specification.

### BRIEF DESCRIPTION OF THE DRAWINGS

FIG. 1 is a block diagram of one potential embodiment of a computer within the system;

FIG. 2 is a block diagram of a system 200 according to an embodiment of the present invention;

FIG. 3 is a flowchart showing the steps used in the present method 300; and

FIG. 4 illustrates a depiction of an exemplar mixer graphical user interface (GUI) 302 that may be used in the permanent alignment of text utterances to their associated audio utterances.

### DETAILED DESCRIPTION OF THE INVENTION

While the present invention may be embodied in many different forms, there is shown in the drawings and discussed herein a few specific embodiments with the understanding that the present disclosure is to be considered only as an exemplification of the principles of the invention and is not intended to limit the invention to the embodiments illustrated.

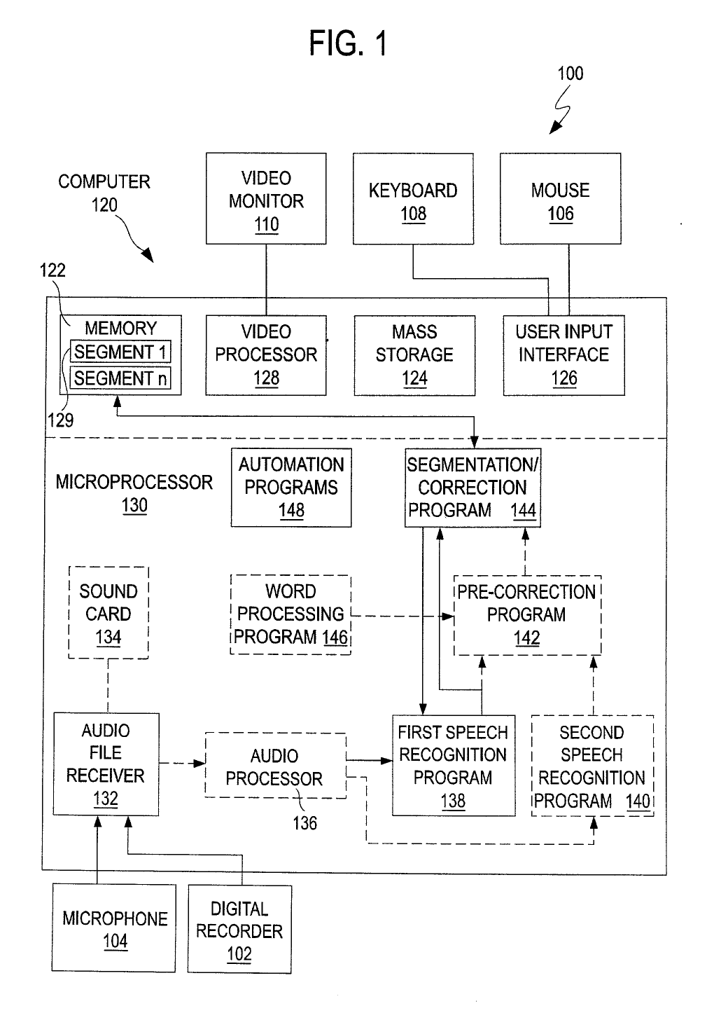

FIG. 1 is a block diagram of one potential embodiment of a computer within a system 100. The system 100 may be part of a speech recognition system works towards permanently aligning text utterances to their associated audio utterances. This may, for example, allow distribution of a transcribed audio file from a first computer to a second computer.

The system 100 may include input/output devices, such as a digital recorder 102, a microphone 104, a mouse 106, a keyboard 108, and a video monitor 110. Moreover, the system 100 may include a computer 120. As a machine that performs calculations automatically, the computer 120 may include input and output (I/O) devices, memory, and a central processing unit (CPU).

Preferably the computer 120 is a general-purpose computer, although the computer 120 may be a specialized computer dedicated to directing the output of a pre-recorded audio file into a speech recognition program. In one embodiment, the computer 120 may be controlled by the WINDOWS 9.x operating system. It is contemplated, however, that the system 100 would work equally well using a MACINTOSH computer or even another operating system such as a WINDOWS CE, UNIX or a JAVA based operating system, to name a few.

In one arrangement, the computer 120 includes a memory 122, a mass storage 124, a user input interface 126, a video processor 128, and a microprocessor 130. The memory 122 may be any device that can hold data in machine-readable format or hold programs and data between processing jobs in memory segments 129 such as for a short duration (volatile) or a long duration (non-volatile). Here, the memory 122 may include or be part of a storage device whose contents are preserved when its power is off.

The mass storage 124 may hold large quantities of data through one or more devices, including a hard disc drive (HDD), a floppy drive, and other removable media devices such as a CD-ROM drive, DITTO, ZIP or JAZ drive (from Iomega Corporation of Roy, Utah).

The microprocessor 130 of the computer 120 may be an integrated circuit that contains part, if not all, of a central processing unit of a computer on one or more chips. Examples of single chip microprocessors include the Intel Corporation PENTIUM, AMD K6, Compaq Digital Alpha, or Motorola 68000 and Power PC series. In one embodiment, the microprocessor 130 includes an audio file receiver 132, a sound card 134, and an audio preprocessor 136.

In general, the audio file receiver 132 may function to receive a pre-recorded audio file, such as from the digital recorder 102 or the microphone 104. Examples of the audio file receiver 132 include a digital audio recorder, an analog audio recorder, or a device to receive computer files through a data connection, such as those that are on magnetic media. The sound card 134 may include the functions of one or more sound cards produced by, for example, Creative Labs, Trident, Diamond, Yamaha, Guillemot, NewCom, Inc., Digital Audio Labs, and Voyetra Turtle Beach, Inc.

The microprocessor 130 may also include at least one speech recognition program, such as a first speech recognition program 138 and a second speech recognition program 140. The microprocessor 130 may also include a pre-correction program 142, a segmentation correction program 144, a word processing program 146, and assorted automation programs 148.

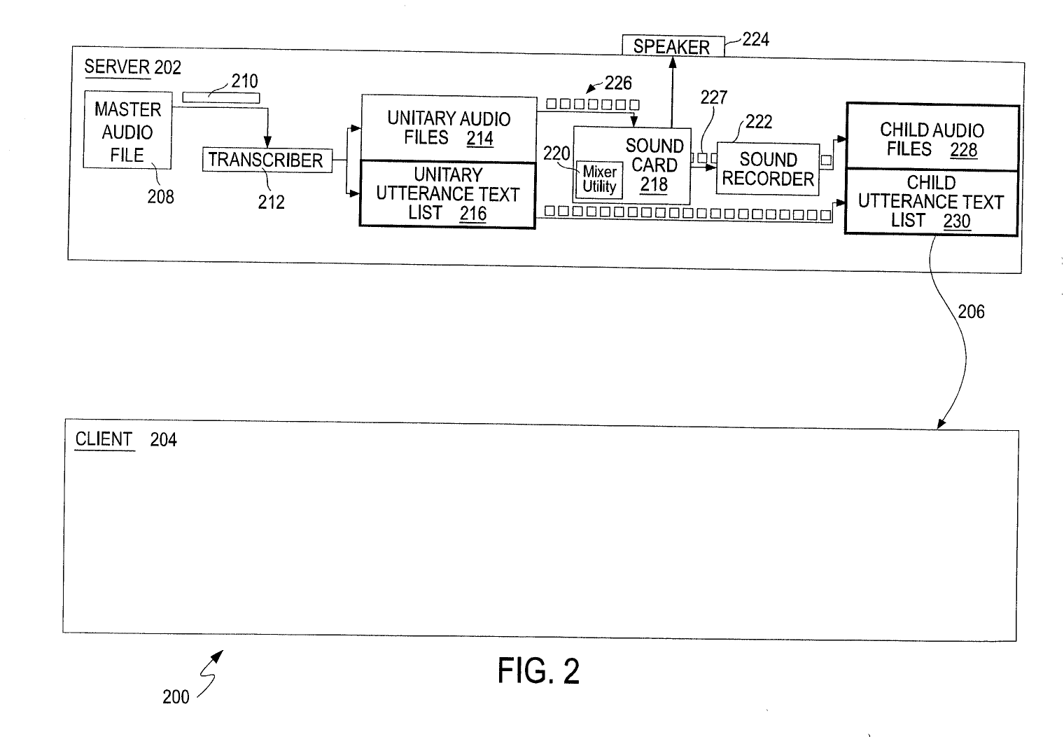

FIG. 2 is a block diagram of a system 200 according to an embodiment of the present invention. The system 200 may include a server 202 and a client 204. A network 206 may connect the server 202 and the client 204.

The server 202 may include various hardware components such as those of the system 100 in FIG. 1. The server 202 may include one or more devices, such as computers, connected so as to cooperate with one another. Similar to the server 202, the client 204 may include one or more devices, such as computers, connected so as to cooperate with one another. The client 204 may be a set of clients 204, each connected to the server 202 through the network 206. Moreover, the client 204 may include a variety of hardware components such as those of the system 100 in FIG. 1.

The network 206 may be a network that operates with a variety of communications protocols to allow client-to-client and client-to-server communications. In one embodiment, the network 206 may be a network such as the Internet, implementing transfer control protocol/internet protocol (TCP/IP).

As seen in FIG. 2, the server 202 may include a master audio file 208. The master audio file 208 may be a pre-recorded audio file saved or stored within an audio file receiver (not shown) of the server 202. The audio file receiver of the server 202 may be the audio file receiver 132 of FIG. 1.

As a pre-recorded audio file, the master audio file 208 may be thought of as a “.WAV” file. This “.WAV” file may be originally created by any number of sources, including digital audio recording software; as a byproduct of a speech recognition program, or from a digital audio recorder. Other audio file formats, such as MP2, MP3, RAW, CD, MOD, MIDI, AIFF, mu-law or DSS, may also be used to format the master audio file 208.

In some cases, it may be necessary to pre-process the master audio file 208 to make it acceptable for processing by speech recognition software. For instance, a DSS or RAW file format may selectively be changed to a .WAV file format, or the sampling rate of a digital audio file may have to be upsampled or downsampled. Software to accomplish such pre-processing is available from a variety of sources, including the Syntrillium Corporation and the Olympus Corporation.

In a previously filed, co-pending patent application, the inventor of the present patent teaches a system and method for quickly improving the accuracy of a speech recognition program. That system is based on a speech recognition program that automatically converts a pre-recorded audio file, such as the master audio file 208, into a written text. That system parses the written text into segments, each of which is corrected by the system and saved in an individually retrievable manner in association with the computer. In that system, the speech recognition program saves the standard speech files to improve accuracy in speech-to-text conversion. That system further includes facilities to repetitively establish an independent instance of the written text from the pre-recorded audio file using the speech recognition program. That independent instance can then be broken into segments. Each segment in the independent instance is replaced with an individually retrievable saved corrected segment, which is associated with that segment. In that manner, the inventor's prior application teaches a method end apparatus for repetitive instruction of a speech recognition program.

In another, previously filed, co-pending patent application, the inventor of the present patent discloses a system for further automating transcription services in which a voice file is automatically converted into first and second written texts based on first and second set of speech recognition conversion variables, respectively. For instance, disclosed in this prior application is that the first and second sets of conversion variables have at least one difference, such as different speech recognition programs, different vocabularies, and the like.

The master audio file 208 may be sent as a stream 210 to the transcriber 212. The transcriber 212 may be configured to receive the master audio file 208 and transcribe it into unitary audio files 214 and a unitary utterance text list 216, having entries 218 (not shown) associated with the individual unitary audio files 214. The transcriber 112 may be part of a speech recognition system. In one embodiment, the transcriber 212 is part of a Dragon NaturallySpeaking® speech recognition software product by L&H Dragon Systems, Inc. of Newton, Mass.

In using various executable files associated with Dragon Systems' Naturally Speaking to transcribe pre-recorded audio files such as the master audio file 208, a pre-recorded audio file (usually “.WAV”) first is selected for transcription. The selected pre-recorded audio file is sent to the TranscribeFile method of Dictation Edit Control module provided by the Dragon Software Developers' Kit (Dragon “SDK”). As the audio from the audio file is being transcribed, the location of each segment of text is determined automatically by the speech recognition program. For instance, in Dragon, an utterance is defined by a pause in the speech. As a result of Dragon completing the transcription, the text is internally “broken up” into segments according to the location of the utterances.

Dragon has a technique of uniquely identifying each utterance. In particular, the location of the segments is determined by the Dragon SDK UtteranceBegin and UtteranceEnd methods of Engine Control module, which report the location of the beginning of an utterance and the location of the end of an utterance. For example, if the number of characters to the beginning of the utterance is 100, and to the end of the utterance is 115, then the utterance begins at 100 and has 15 characters (100, 15). If the following utterance is 22 characters long, then the next utterance begins at 116 and has 22 characters (116, 22). For reference, the location of utterances is stored in a listbox (not shown).

In Dragon's Naturally Speaking program, these speech segments vary from 2 to, say, 20 words depending upon the length of the pause setting in the Miscellaneous Tools section of Dragon Naturally Speaking. If the end user makes the pause setting longer more words will be part of an utterance because a long pause is required before Naturally Speaking establishes a different utterance. If the pause setting is made short then there will be more utterances with few words. Once transcription ends (using the TranscribeFile method), the text is captured.

The location of the utterances (using the UtteranceBegin and UtteranceEnd methods) is then used to break apart the text to create a list of utterances, shown in FIG. 2 as the unitary utterance text list 216. So long as a unitary audio file 214 and its associated text from the unitary utterance text list 216 are “active” within the Dragon software program on a computer, Dragon maintains audio-text alignment. When the unitary audio file 214 and its associated text from the unitary utterance text list 216 are no longer active within the Dragon software program, Dragon no longer maintains audio-text alignment.

Audio-text alignment allows a user to playback the audio associated with an utterance displayed within a correction window. By comparing the audio for the currently selected speech segment with the selected speech segment, appropriate correction may be determined. If correction is necessary, then that correction is manually input with standard computer techniques. Unfortunately, when at least one of the audio and text is distributed or other shared with another computer, there is no known way to transfer the Dragon audio-text alignment from that initial computer to the other computer(s). The inventor has discovered that this is true even if those computers are connected across a computer network.

By way of summary, the present invention takes advantage of Dragon's technique of uniquely identifying each utterance to find the text for audio playback and automated correction. On playing back the unitary audio files 214, the invention creates a second or child single audio utterance 227 and aligns these child single audio utterances 227 with the unitary utterance text list 216.

To accomplish this playback, the server 202 may include a sound card 218 having a mixer utility 220 and a sound recorder 222 coupled to the sound card 218. A speaker 224 may be coupled to the sound card 218.

The sound card 218 may be a plug-in optional circuit card that provides high-quality stereo sound output under program control. Moreover, Creative Labs, Trident, Diamond, Yamaha, Guillemot, NewCom, Inc., Voyetra Turtle Beach, Inc., and Digital Audio Labs may produce the sound card 218.

The mixer utility 220 may include optional settings that determine an input source and an output path for the sound card 218. The setting of the mixer utility 220 may be used to mute audio output to the speaker 222 associated with the server 202. These settings may be saved before changing the settings of the mixer utility 218 to specify a mixer input source.

The sound recorder 222 may be a media player having a system that is voice-activated and configured to receive input from the sound card 218. The settings of the mixer utility 218 also may be restored to saved sound card mixer settings after the sound recorder 222 finishes playing the unitary audio files 214.

In operation, a unitary audio file 214 may send the packets 226 to the sound card 218. The sound card 218 may be configured to accept wave-in rather than its standard setting. The packets 226 may include a first single audio utterance from the unitary audio file 214. On receiving the packets 226, the sound card 218 may play the unitary audio file 214 utterance by utterance in the server 202 to create the child single audio utterances 227. This playback may be achieved by using a playback program in combination with the utterance locations as set out in the unitary utterance text list 216 in the server 202. The playback program may be the playback function of the Dragon SDK.

In the Dragon SDK, the played audio conventionally is directed from the sound card 218 to the speaker 224. In the present invention, the mixer utility 220 may be set to direct the output of the sound card 218 to the sound recorder 222. On receiving the output of the sound card 218, the voice-activated capabilities of the sound recorder 222 cause the sound recorder 222 to record each audio file as a separate, child audio file 228 for each utterance location 216. Each utterance location 216 may follow its associated packet 226/child single audio utterances 227/child audio file 228 into a child utterance text list 230. In other words, by then directing the sound recorder 222 with voice-activated capabilities to receive the input of the sound card 218, separate audio files 228 for each utterance location 230 can be created. The alignment between the child audio files 228 and the child utterance text list 230 may be stored on a more permanent medium, such as the memory 122 or the mass storage 124 of the system 100 in FIG. 1.

There may be situations where the sound recorder 222 does not detect an end of one or more audio utterances due to, for example, the time period between such audio utterances. Here, a safety margin may be added by inserting a predetermined pause between playback of each utterance, which would, due to the longer silent period, work towards ensuring that the sound recorder 222 detects the end of each audio utterance. Once the unitary audio files 214 are reproduced as the child audio files 228, the correspondence between audio files 228 and the text 230 may be transmitted and recreated on client 204.

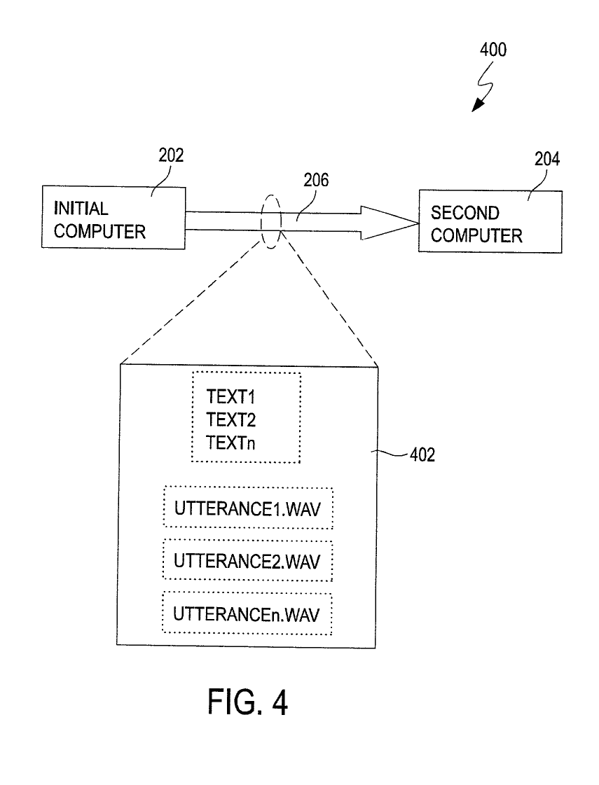

The audio files 228 may be named in various ways to indicate the utterance contained therein to facilitate alignment. For instance, Sagebrush's RecAllPro sound recorder provides voice-activated functionality along with a facility to sequentially name files. By utilizing this sequentially naming files utility, the alignment may be easily noted. Alternatively, a unique code may be prepared to achieve the same alignment result in combination with any media player having voice-activated response capabilities (See, e.g., FIG. 4). The end result is a series of sequentially numbered files, each containing a word or utterance (depending upon the underlying speech processing software).

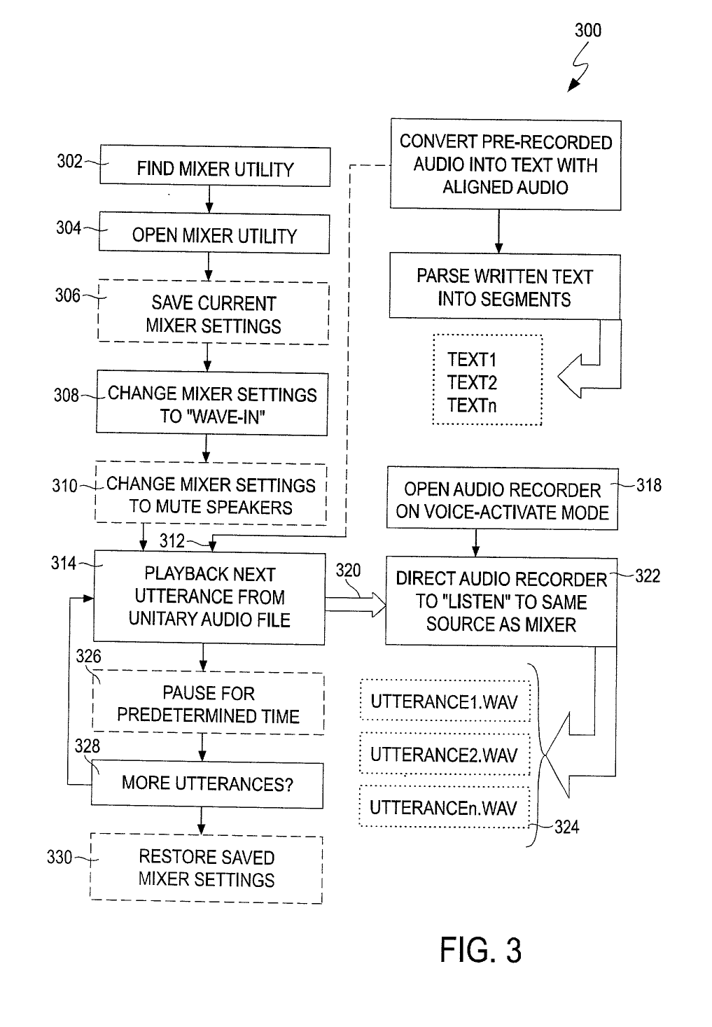

FIG. 3 is a flowchart showing the steps used in the present method 300. In particular the following steps are used as an example implementation of method 300.

At 302, the method 300 may use the functionality of the operating system of the server 202 to find the mixer utility 220 associated with the sound card 218. At 304, the mixer utility 220 may be opened. FIG. 4 illustrates a depiction of an exemplar mixer graphical user interface (GUI) 402 that may be used in the permanent alignment of text utterances to their associated audio utterances. At 306, the current mixer settings of the sound card 218 may be saved. At 308, the mixer setting of the sound card 218 may be set to “wave in.” Here, the mixer setting of the sound card 218 may be changed from “microphone” or other setting to the wave in setting.

The output path of the sound card 218 conventionally is directed to the speakers 224. Where this is the case, the method 300 may change the change the mixer setting of the sound card 218 at step 310 to mute, so as to mute the output of the speaker 224.

With the settings of the sound card 218 positioned as desired, the sound card 218 may receive first single audio utterance 226 at 312. At 314, the sound card 218 may playback a first single audio utterance 226 utterance by utterance (or word by word) into the sound card 218. This playback of the first single audio utterance 226 may be achieved by, for example, utilizing a playback function from a speech recognition engines' software developers' kit. At 316, a silent pause of a predetermined duration may be inserted into the playback output to create a child single audio utterance 227, which is based on the first single audio utterance 226. This silent pause may be anywhere from 0.01 seconds to more than 10 seconds, although a short silent pause duration of 1-2 seconds is preferred.

At 318, the audio or sound recorder 220 may be opened on voice-activate mode with an end of file indication set as a function of the silent pause. Preferably, the end of file indication looks for a silent pause that is shorter in duration than that set in step 316. At 320, the sound recorder 222 may receive the output 227 of the sound card 218.

At 322, the sound recorder 222 may be directed to “listen” to the same source as the sound card mixer is set at step 308. For example, the sound recorder 222 may be directed to “listen” to the same source as the sound card mixer is set to “wave in.” At 324, each child audio file 228 may be named. Preferably, each child audio file 228 is named using a base name and sequential suffix (i.e. utterancel.WAV, utterance2.WAV, . . . , utterancen.WAV). By using software, such as RecAllPro from Sagebrush of Corrales, N. Mex., sequentially numbered audio files are created.

At step 326, the playback function addressed in step 314 is paused for the predetermined time set out in step 316. The method 300 then determines at step 328 whether there are more audio utterances 226. If there are more audio utterances 226, then the method 300 returns to step 314. If there are no more audio utterances 226, the method proceeds to step 330. At step 330, the mixer settings of the sound card 218 saved in step 306 may be restored.

A machine-readable medium includes any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.). Methods in accordance with the various embodiments of the invention may be implemented by computer readable instructions stored in any media that is readable and executable by a computer system. For example, a machine-readable medium having stored thereon instructions, which when executed by a set of processors, may cause the set of processors to perform the methods of the invention.

The foregoing description and drawings merely explain and illustrate the invention and the invention is not limited thereto. While the specification in this invention is described in relation to certain implementation or embodiments, many details are set forth for the purpose of illustration. Thus, the foregoing merely illustrates the principles of the invention. For example, the invention may have other specific forms without departing for its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A method for permanently aligning text utterances to their associated audio utterances, the method comprising:
playing a first single audio utterance from a unitary audio file to produce a child single audio utterance, wherein the first single audio utterance is aligned with a first text utterance;
recording the child single audio utterance into a child audio file; and
aligning the child single audio utterance with the first text utterance.

2. The method of claim 1, wherein playing the first single audio utterance includes setting a mixer utility associated with a sound card to direct the output of the sound card to a sound recorder.

3. The method of claim 2, prior to setting the mixer utility, storing initial settings of the mixer utility.

4. The method of claim 3, after recording the child single audio utterance into a child audio file, the method further comprising:
resetting the mixer utility to the initial settings.

5. The method of claim 1, wherein recording the child single audio utterance includes sending an output of a sound card to a sound recorder.

6. The method of claim 1, after aligning the child single audio utterance with the first text utterance, the method further comprising:
transmitting the child single audio utterance aligned with the first text utterance.

7. A computer implemented method for permanently aligning text utterances to their associated audio utterances, the method comprising:
(a) finding a mixer utility associated with a sound card;
(b) opening the mixer utility, the mixer utility having settings that determine an input source and an output path;
(c) playing a first single audio utterance from a unitary audio file to produce a child single audio utterance;
(d) recording the child single audio utterance into a child audio file; and
(e) repeating (c) through (d) until all first single audio utterances from the unitary audio file have been played.

8. The method of claim 7, further comprising:
changing the mixer utility settings to mute audio output to speakers associated with the sound card.

9. The method of claim 7, further comprising:
saving the settings of the mixer utility;
changing the settings of the mixer utility to specify the input source; and
restoring the saved settings of the mixer utility after all first single audio utterances from the unitary audio file have been played.

10. The method of claim 7, wherein the first single audio utterance is aligned with a first text utterance, the method further comprising:
aligning the child single audio utterance with the first text utterance.

11. The method of claim 7, wherein recording the child single audio utterance includes sending an output of a sound card to a sound recorder.

12. The method of claim 7, after all first single audio utterances from the unitary audio file have been played, the method further comprising:
transmitting from the child audio file at least one of the child single audio utterances.

13. The method of claim 7, after recording the child single audio utterance into a child audio file, sequentially naming the child single audio utterance.

14. A machine-readable medium having stored thereon instructions, which when executed by a set of processors, cause the set of processors to perform the following:
(a) finding a mixer utility associated with a sound card;
(b) opening the mixer utility, the mixer utility having settings that determine an input source and an output path;
(c) playing a first single audio utterance from a unitary audio file to produce a child single audio utterance;
(d) recording the child single audio utterance into a child audio file; and
(e) repeating (c) through (d) until all first single audio utterances from the unitary audio file have been played.

15. The machine-readable medium of claim 14, further comprising:
changing the mixer utility settings to mute audio output to speakers associated with the sound card.

16. The machine-readable medium of claim 14, further comprising:
saving the settings of the mixer utility;
changing the settings of the mixer utility to specify the input source; and
restoring the saved settings of the mixer utility after all first single audio utterances from the unitary audio file have been played.

17. The machine-readable medium of claim 14, wherein the first single audio utterance is aligned with a first text utterance, the method further comprising:
aligning the child single audio utterance with the first text utterance.

18. The machine-readable medium of claim 14, wherein recording the child single audio utterance includes sending an output of a sound card to a sound recorder.

19. The machine-readable medium of claim 14, after all first single audio utterances from the unitary audio file have been played, the method further comprising:
transmitting from the child audio file at least one of the child single audio utterances.

20. The machine-readable medium of claim 14, after recording the child single audio utterance into a child audio file, sequentially naming the child single audio utterance.
